(19) United States
(12) Patent Application Publication
(10) Pub. No.: US 2006/0071438 A1
(43) Pub. Date: Apr. 6, 2006

(54) Quick assembly, minimal effort carriage for moving heavy objects

(76) Inventor: Ezzat G. Bakhoum, Marlton, NJ (US)

Correspondence Address: EZZAT G. BAKHOUM, P.O. Box 305, Marlton, NJ, 08053, US

(21) Appl. No.: 11/294,271

(22) Filed: Dec. 5, 2005

Related U.S. Application Data
(63) Continuation-in-part of application No. 10/238,551, filed on Sep. 10, 2002, now Pat. No. 6,955,368.

(51) Int. Cl. B62B 5/00

(52) U.S. Cl. 280/79.11

(57) ABSTRACT

In a broad aspect, the invention is a kit used for mobilizing heavy objects such as items of furniture, boxes, appliances, etc. The apparatus is based on a plurality of rigid support structures, or “shoes”, which are to be inserted under the corners of the item to be moved. Those support structures carry longitudinal and transverse conduits which can accept long, rigid link members, such as rods. The rods or link members are fastened to each other by means of screw-like threads, and are finally fastened to the conduits in the shoes. The net result is the formation of a rigid “cage” around the item to be moved. Each of the shoes is equipped with a wheel that is originally elevated above the ground plane. By lifting the rigid cage slightly on each side, the wheels will drop vertically and remain engaged. The cage, carrying the heavy object, can then be moved effortlessly.

### CROSS-REFERENCE TO RELATED APPLICATION

This is a Continuation-in-Part of U.S. application Ser. No. 10/238,551 filed Sep. 10, 2002 in the name of Ezzat G. Bakhoum for “Quick Assembly, Minimal Effort Carriage for Moving Heavy Objects”, now U.S. Pat. No. 6,955,368.

### BACKGROUND OF THE INVENTION

1. Field of the invention:

This invention relates to a method and an apparatus to facilitate the movement of large, heavy objects, such as furniture, boxed items, etc., inside a home, building or factory.

2. Description of the related art:

At the present time, there is no simple solution for moving heavy objects, such as furniture items, inside a home or a factory, unless the item is already mounted on wheels. Apart from using heavy industrial equipment, such as a fork lift for example, a number of simple methods exist in the prior art to facilitate the movement of heavy objects. Unfortunately, none of those so called “simple” solutions is really effective. One solution, currently available in the market, and is shown in patents like U.S. Pat. No. 4,025,676, is based on the concept of inserting a smooth plastic dish or strip under the legs of the item to be moved in order to minimize friction. Experience has shown, however, that unless the item is relatively light, friction still represents a major problem. Another solution, such as the solution shown in U.S. Pat. No. 5,772,223, is to attach wheels temporarily to the legs of the item to be moved by using clamps. Unfortunately, if the item has no legs, or if it does have irregularly-shaped legs (i.e., not a cylinder or a square), then attaching clamps will be very difficult or impossible. In addition, considerable effort need to be exerted by the user to keep the item lifted while the clamps are being attached. Other solutions are shown in U.S. Pat. Nos. 5,709,397 and 5,938,217. The U.S. Pat. No. 5,709,397 patent shows a dolly that can be used to lift a heavy object by means of side-rails mounted on the object. This idea, of course, cannot be used to move objects which have no such side-rails. The U.S. Pat. No. 5,938,217 patent is based on the idea of inserting support rails under the item to be lifted and lifting the rails by means of turning side-bolts which are mounted on a rigid structure equipped with wheels. This invention, however, suffers from a number of deficiencies. First, the insertion of rails under a heavy item may be too difficult and can damage the floor underneath the rails. Secondly, the idea cannot be used with legged items (which is the case in many furniture models). Finally, the process of turning a plurality of bolts to lift the item can be very time consuming.

It is the objective of the present invention to provide a method and apparatus for moving heavy furniture items, boxes, appliances, etc., which is characterized by:
Can be assembled in seconds;
The assembly can be done by one person, with minimal effort;
Does not require any modifications to existing items;
Can be used with legged or non-legged items;
Highly effective, since the item to be moved is mounted on wheels; and
Quite inexpensive, which makes it suitable for home use as well as industrial use.

Other objectives and features of the invention will become fully apparent from the ensuing disclosure and appended claims.

### SUMMARY OF THE INVENTION

In a broad aspect, the invention is based on a plurality of rigid support structures, or “shoes”, which are to be inserted under the corners of the item to be moved. Those support structures carry longitudinal and transverse conduits which can accept long, rigid link members, such as rods. The rods or link members are fastened to each other by means of screw-like threads, and are finally fastened to the conduits in the shoes. The net result is the formation of a rigid “cage” around the item to be moved. Each of the shoes is equipped with a wheel that is originally elevated above the ground plane. A mechanism inside the wheel assembly permits the wheel to drop vertically and remain engaged, once the shoe is lifted above the ground plane. Thus, by lifting the rigid cage slightly on each side, the wheels will engage and the cage will become mounted on wheels. The cage, carrying the heavy object, can then be moved effortlessly.

### BRIEF DESCRIPTION OF THE DRAWINGS

FIG. 1 shows a detailed view of the shoe, or support structure of the present invention, inserted under the leg of a furniture item. The figure shows a conduit in the shoe; the wheel attached to the shoe; and the rods which are to be inserted in the conduit.

FIG. 2 shows the completely assembled apparatus of the present invention, carrying the furniture item.

FIG. 3 shows the detail of the fastening mechanism inside the conduit, which permits a rod to be fastened to the conduit.

FIG. 4 shows the inner working mechanism of the vertical rod that carries the wheel. This mechanism permits the engagement/disengagement of the wheel assembly to/from the shoe or support structure.

FIG. 5 shows a possible reciprocating mechanism to perform the engagement/disengagement function, which can be used in a different embodiment of the invention.

FIG. 6 shows another embodiment of the apparatus of the present invention.

FIG. 7 shows yet another embodiment of the apparatus of the present invention.

### DETAILED DESCRIPTION OF THE INVENTION, AND PREFERRED EMBODIMENTS THEREOF

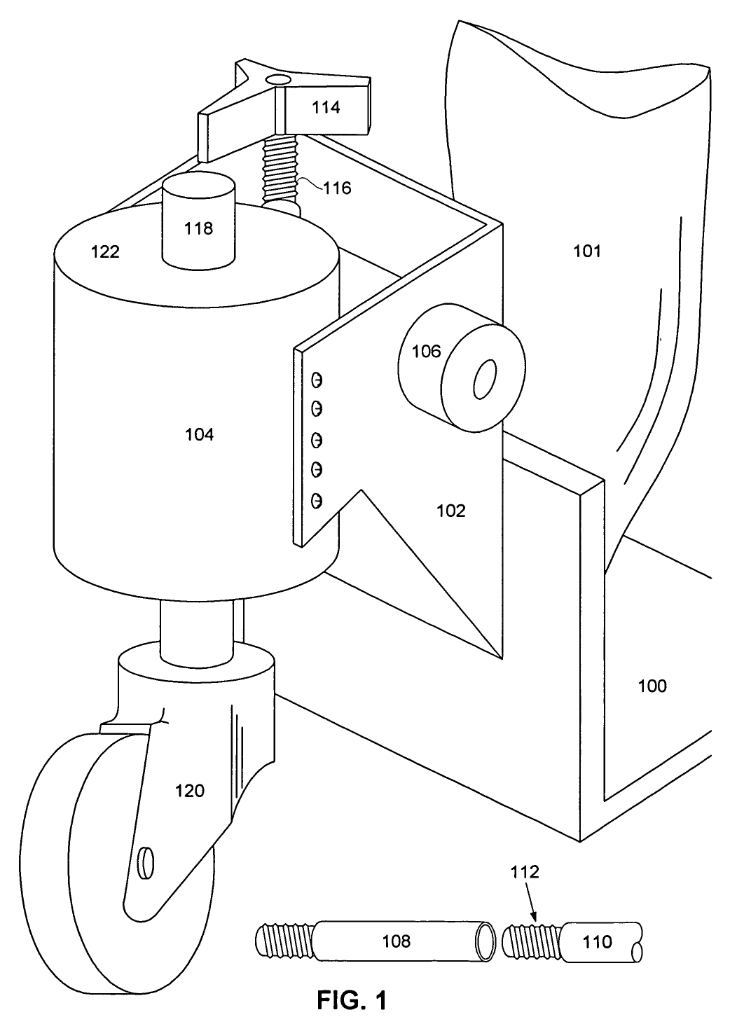

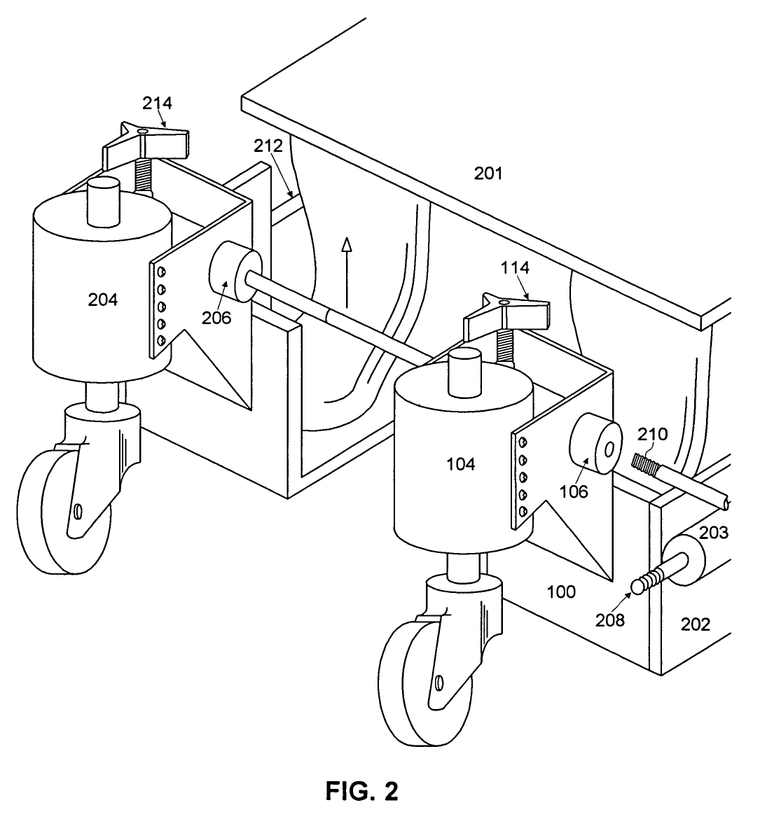

FIG. 1 shows the preferred embodiment of the invention. As shown, an angular section 100, preferably made of steel or aluminum, is inserted under a corner of the heavy item that is to be moved. The corner may be a leg, such as the leg 101 shown in the figure, or may be a non-legged corner, such as the corner of a box (the inner surfaces the angular section 100 may be padded in order to prevent damage to the corner of the object being carried). Attached to the angular section 100 is a steel bracket 102, to which a cylindrical housing 104 may be welded or mounted with screws. Similar angular sections are to be inserted under the remaining legs or corners of the object. As shown in the figure, a transverse conduit 106 passes through the bracket 102. This conduit can accept a rod 108 for insertion into the conduit. Another rod 110 is to be attached to rod 108 by means of a screw-like thread 112, as shown. Other rods are to be attached serially to rod 110 and are not shown in the figure. These rods are also preferably made of steel; though aluminum may be used as a lighter alternative. Another alternative, still, is to use hollow tubes instead of rods. The angular section 100 also carries another, longitudinal conduit that is not shown in the figure but will be shown in FIG. 2. Once rod 108 is inserted into the transverse conduit 106, it can be secured in position by turning a plastic knob 114. This knob has the purpose of tightening or loosening a clamp inside the conduit, as will be explained later, by means of a vertical screw 116. The total length of the rods used in the transverse direction (i.e., rod 108 plus the other rods attached serially to it) must equal or exceed the width of the item to be moved.

The housing 104, preferably made of steel, carries a vertical steel rod 118, to which a caster 120 is attached. The vertical rod is guided by the upper lid 122 of the housing and similarly by the lower lid of that housing. Inside the vertical rod 118 exist an intricate mechanism for controlling the movement of the rod. Specifically, when the entire support structure is lifted up, the wheel drops a certain pre-specified distance and the rod 118 latches in position inside the housing and becomes immobile. When the support structure is lifted again, the rod disengages from the housing and the wheel becomes free to move. More detail about that mechanism will be given below.

FIG. 2 shows the fully assembled apparatus, according to the preferred embodiment, carrying a furniture item 201. As shown, the angular section 100 is further equipped with a side-plate 202 that is welded to it. The side-plate carries a longitudinal conduit 203, of a length that is preferably the same as the length of the transverse conduit 106. As in the transverse direction, a number of rods, starting with rod 208, are inserted sequentially into conduit 203 and fastened to each other. The total length of the rods used in the longitudinal direction must equal or exceed the depth of the item to be carried, 201. The steps of the assembly are as follows: the angular section 100 is first inserted under the leg or corner of the furniture item as described above. The other three assemblies are similarly inserted under the other respective legs or corners (note that only the front view is shown in figure, in which only two of those assemblies appear). A number of transverse rods, starting with rod 210 and serially attached to each other as shown in the figure, are then inserted first through conduit 106 and then through conduit 206 (or the opposite). As stated above, the combined length of these rods must equal or exceed the width of the furniture item 201. For that purpose, these rods must preferably be supplied as a kit containing different sizes; for example: 2 ft, 1 ft, 6 inches and 3 inches. This will allow fine-adjustment of the total length, if necessary, to accommodate the passage of the assembly through tight doorways, etc. The next step is the insertion of the longitudinal rods, as explained, through conduit 203 and then through the next conduit in the longitudinal direction (not shown in the figure). In addition, longitudinal and transverse rods are to be inserted on the other sides of the assembly, as shown in the figure (see the longitudinal rod 212 on the left-hand side of the assembly). Finally, the rod assemblies are to be secured in position by hand tightening the knobs 114, 214, and the other knobs not shown in the figure (there will be a total of 8 knobs in this apparatus). Practically, a rigid “cage” has now been formed around the furniture item. The last step is to engage the wheels, since, as the wheels are free to move up or down, they are now at or above the ground level. This step is accomplished by simply lifting the entire assembly up by a few inches, preferably by pulling on the middle section of the transverse rods (in the direction indicated by the upwardly pointing arrow in FIG. 2). The front wheels will now drop a pre-specified distance and the mechanisms inside the supporting rods (to be discussed later) will latch inside the housings 104 and 204 and fix the supporting rods in place. The step is then repeated on the other side to engage the back wheels. The entire assembly process, as described, should take only seconds. It is to be noted that the size of the apparatus is exaggerated in the figure with respect to the furniture item for the purpose of clarity.

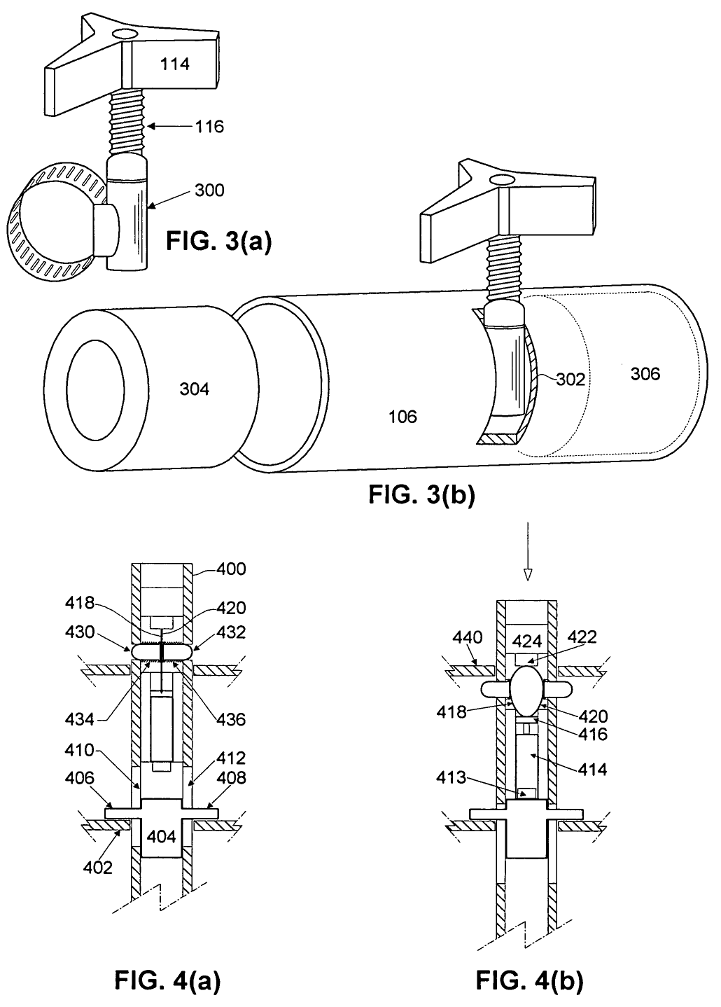

Reference is now made to FIG. 3. This figure shows the fastening mechanism used inside each of the conduits for the purpose of fastening the link rods to the conduits. In FIG. 3(a), the knob 114 turns a vertical screw 116 that is welded or glued to a ring clamp 300. Those ring clamps are usually made of stainless steel and are commonly found in hardware stores. The assembly in FIG. 3(a) is inserted through a slot 302 on the side of the conduit 106, as shown in FIG. 3(b). The conduit itself should preferably be made of aluminum. Two other pieces are then inserted through the conduit: plastic rings 304 and 306 (in the figure, plastic ring 306 is shown in position while ring 304 is shown outside). The fastening process occurs as follows: the longitudinal or transverse rod that passes through conduit 106 is supported by the two plastic rings 304 and 306. The knob 114 is then turned until the ring clamp inside the conduit catches the rod firmly. Now the rod is secured to the conduit because of the fact that the body of the ring clamp is prevented from moving left or right due to the slot 302 in the conduit (see FIG. 3(b)). Disassembly is performed by simply turning the knob in the opposite direction to loosen the clamp and then pulling the rod out of the conduit.

FIG. 4 shows the inner working mechanism of the rod supporting the caster. This mechanism permits the vertical rod 400 to latch to the housing that is supporting it and hence fix the caster in place. The mechanism works on the basis of an interaction between the rod 400 and the lower lid of the housing, 402. As shown in FIG. 4(a), the mechanism inside the rod includes an aluminum plunger 404, which has two extensions 406 and 408. The two extensions 406 and 408 protrude through two slots 410 and 412 on the sides of the rod 400 (the rod 400 must be made of steel). When the caster is above the ground level, the position of the plunger 404 with respect to the slots on the sides of the rod will be as shown in FIG. 4(a). When the entire assembly is lifted up, the caster falls down and hence the rod 400 will move down (in the direction indicated by the arrow in FIG. 4(b)). Since the lower lid 402 is a part of the assembly that is being lifted, then the position of the plunger 404 with respect to the rod will now be as shown in FIG. 4(b). In that position, the plunger pushes against a button 413 that is attached to a reciprocating mechanism 414. Such a reciprocating mechanism is preferably the one found in most pens. Usually made of plastic, such a reciprocating mechanism includes a pushbutton 413 and a small hammer 416. The button 413 is pushed once and the hammer advances to the position shown in FIG. 4(b). The button is pushed again and the hammer retreats to the position shown in FIG. 4(a). As the rod 400 falls and the hammer 416 advances up, the hammer in turn pushes against two strips of spring steel, 418 and 420, shown in side-view in FIG. 4(b). The two strips 418 and 420 are supported on the other side by a small piece of rubber 422 that is attached to an aluminum support 424. The operation of the mechanism is as follows: when the entire structure is resting on the ground, the configuration is as shown in FIG. 4(a). The two spring steel strips 418 and 420 are perfectly vertical, since they are not subjected to any force. Against the flat sides of the two strips (which are perpendicular to the drawing), two lock-pins 430 and 432 push in opposite directions to each other, under the forces of two soft springs 434 and 436. When the apparatus is lifted, the rod 400 falls and the plastic hammer 416 advances as explained above. The hammer now experts a vertical force on the two spring steel strips 418 and 420, which deforms them as shown in FIG. 4(b). This deformation of the two strips in turn pushes the two lock-pins 430 and 432 outside the body of the rod, as shown. Now the apparatus is left to relax; the caster attached to the rod pushes against the ground; and hence the rod moves up. The rod will not return to the position shown in FIG. 4(a), however, since the lock-pins will now prevent the advancement of the rod, due to the presence of the upper lid 440 of the housing that contains the rod. The result is that the entire apparatus will be suspended in the elevated position and will be supported by the wheels. When the structure is lifted one more time, the button 413 of the reciprocating mechanism is pushed again and the hammer 416 retreats. Accordingly, the two strips 418 and 420 become flat again and the two lock-pins 430 and 432 retread once again inside the rod. Now the apparatus is left to relax again, and this time the rod returns to the original position shown in FIG. 4(a). As a result, the entire apparatus will be lowered fully to the ground, and the kit can be disassembled.

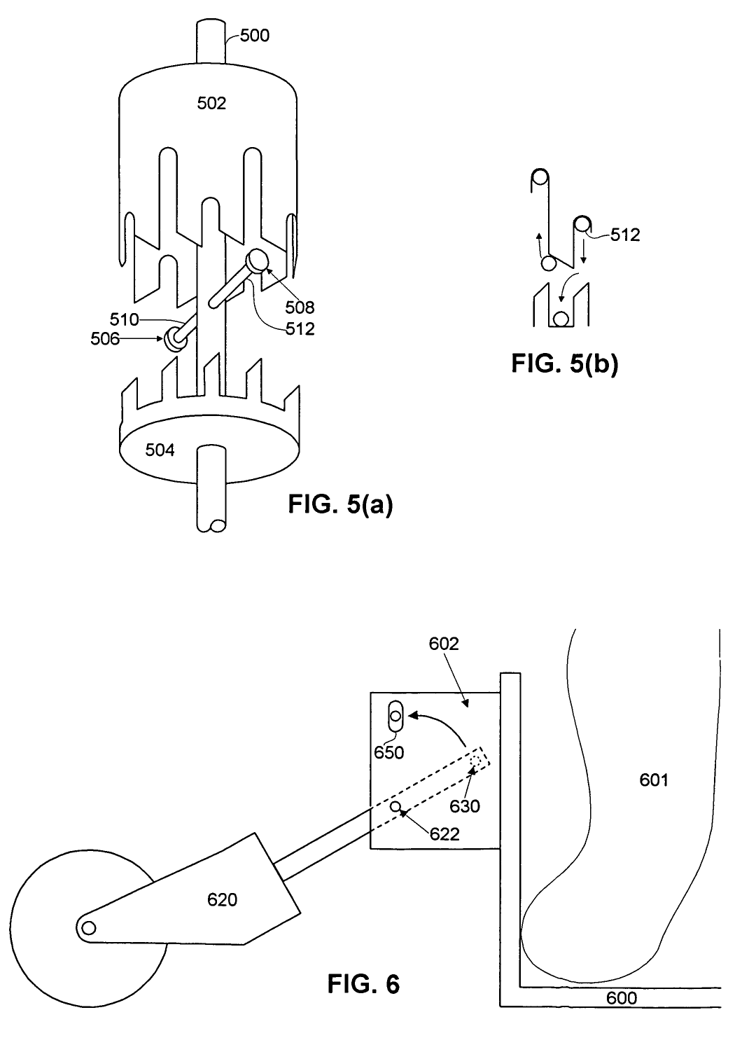

As an alternative to the mechanism shown in FIG. 4, another reciprocating mechanism that serves the same purpose is shown in FIG. 5. The mechanism consists of two half-cylinders, 502 and 504. The circumference of the lower half-cylinder consists of teeth, as shown. The circumference of the upper half-cylinder also consists of teeth, separated by a series of high-low grooves. The rod carrying the caster, 500, is positioned along the center of the mechanism as shown. Two (or more) ball bearings 506 and 508 are attached to the rod 500 via two (or more) arms 510 and 512. The operation of the mechanism is as follows (see FIG. 5(b)): the rod takes a series of high and low positions with respect to the two half-cylinders (which are secured to the supporting structure) by simply moving the half-cylinders up or down. If the rod is in a low position, as shown in FIG. 5(b), then by simply moving the supporting structure up, the rod falls and the ball bearing 512 will now rest between two teeth on the lower half-cylinder, as shown. Now by lowering the supporting structure again, the bearing will slide across a tooth on the upper half-cylinder and finally come to rest inside a high groove as shown. The result once again is that the supporting structure, and hence the entire apparatus, can be either supported on the casters (when the rod 500 is in a low position), or supported on the ground (when the rod is in a high position).

A different embodiment of the invention, though not a preferred one, is shown in FIG. 6. In this configuration, the caster 620 rotates around a fixed point 622 and locks into the vertical position when the supporting structure is lifted. As shown in the figure, the supporting structure 600, carrying a furniture item 601, is equipped with a bracket 602 that features a fixed rotation point 622 for the rod that is attached to the caster. The rod has two lock-pins, 630 and a similar one on the other side. When the support structure is lifted, the caster rotates and the lock-pin is released inside the slot 650 to lock the rod in the vertical position. The slot 650 permits the movement of the lock-pins up and down so that a reciprocating mechanism inside the rod can engage/disengage the lock-pins.

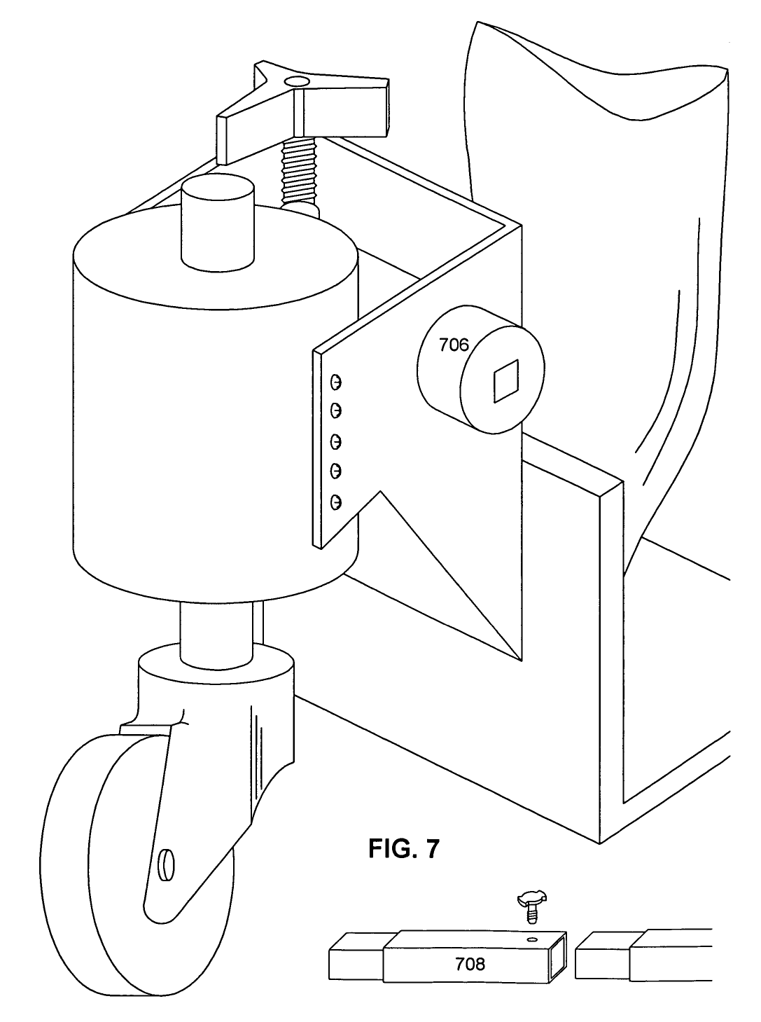

Yet another embodiment of the invention will be as shown in FIG. 7. In this configuration, rectangular link members (such as link member 708) can be used instead of rods or tubes. Such configuration, of course, is much less preferred since it is much harder to attach rectangular link members to each other.

Accordingly, while the invention has been described with reference to specific aspects, features, and embodiments, it will be appreciated that various modifications, alternatives, and other embodiments are possible within the broad scope of the invention, and the invention therefore is intended to encompass all such modifications, alternatives, and other embodiments, within its scope.

What is claimed is:

1. A kit used for mobilizing a heavy object, comprising:
a plurality of rigid support members, each said rigid support member comprising
at least one wheel; means for allowing said wheel to remain at or above the lowest point in said rigid support member when said rigid support member is resting under the force of gravity and for allowing said wheel to drop freely when said rigid support member is lifted,
a mechanism for locking said wheel into position when said wheel drops a pre-specified distance,
an adequate surface to be inserted under a portion of said heavy object when said wheel is at or above the lowest point in said rigid support member,
at least one horizontal conduit for accepting a rigid link member,
means for fastening said horizontal conduit to said rigid link member,
a plurality of said rigid link members, where each rigid link member further comprises means for attachment to other rigid link members.

2. A kit according to claim 1, wherein the at least one wheel is a caster.

3. A kit according to claim 1, wherein the at least one wheel is attached to a metal rod.

4. A kit according to claim 1, wherein the at least one wheel drops a pre-specified distance vertically.

5. A kit according to claim 1, wherein the at least one wheel drops a pre-specified distance rotationally.

6. A kit according to claim 1, wherein a rigid support member comprises longitudinal and transverse conduits.

7. A kit according to claim 1, wherein the inner surfaces of a rigid support member are padded to prevent damage to the object being carried.

8. A kit according to claim 1, constructed and arranged such that each pair of rigid support members are connected to each other by means of at least one link member.

9. A kit according to claim 1, constructed and arranged such that the plurality of rigid support members are totally connected by means of transverse link members.

10. A kit according to claim 1, constructed and arranged such that the plurality of rigid support members are totally connected by means of longitudinal link members.

11. A kit according to claim 1, constructed and arranged such that the plurality of rigid support members are totally connected by means of longitudinal and transverse link members.

12. A kit according to claim 1, constructed and arranged such that it forms a rigid cage around the object being carried when assembled.

13. A kit according to claim 1, wherein the means for fastening the at least one horizontal conduit to a rigid link member comprises a ring clamp that is driven by a knob.

14. A kit according to claim 1, wherein the at least one horizontal conduit comprises plastic guiding rings.

15. A kit according to claim 1, wherein the mechanism for locking the at least one wheel into position comprises:
a plunger with extensions that protrude outside the rod supporting the wheel;
a small reciprocating mechanism;
at least one strip of spring steel;
at least one spring-activated lock pin.

16. A mechanism according to claim 15, further constructed an arranged to effect the disengagement of the wheel from the locked position when the rigid support member is lifted for a second time.

17. A kit according to claim 1, wherein the mechanism for locking the at least one wheel into position comprises:
teeth arranged on a circular circumference, with even grooves between said teeth;
teeth arranged on a circular circumference, with uneven grooves between said teeth;
at least two ball bearings, attached to arms which are perpendicularly supported by the rod carrying the wheel.

18. A mechanism according to claim 17, further constructed an arranged to effect the disengagement of the wheel from the locked position when the rigid support member is lifted for a second time.

19. A kit according to claim 1, wherein the rigid link members are rods.

20. A kit according to claim 1, wherein the rigid link members are tubes.

21. A kit according to claim 1, wherein the rigid link members have rectangular cross sections.

22. A kit according to claim 1, comprising steel parts.

23. A kit according to claim 1, comprising aluminum parts.

24. A kit according to claim 1, comprising steel and aluminum parts.
